(19) United States
(12) Patent Application Publication
(10) Pub. No.: US 2025/0118135 A1
(43) Pub. Date: Apr. 10, 2025

(54) GAMING MACHINE PLAYER INTERFACES AND INTERFACE METHODS

(71) Applicant: Everi Games Inc., Austin, TX (US)

(72) Inventors: Justin Dumas, Meriden, CT (US); William Drobny, Sparks, NV (US); Juan Mariscal, Las Vegas, NV (US)

(21) Appl. No.: 18/905,141

(22) Filed: Oct. 2, 2024

Related U.S. Application Data
(60) Provisional application No. 63/543,103, filed on Oct. 8, 2023.

(51) Int. Cl. G07F 17/32; G07F 17/34

(52) U.S. Cl. CPC G07F 17/3211; G07F 17/3213; G07F 17/34

(57) ABSTRACT

A gaming machine player interface includes a base display mechanism and a modifier display mechanism. The base display mechanism is operable in response to an activation input for displaying a base graphic representation selected from a base set of graphic representations including a number of base numerical values and a graphic representation of a base zero value. The modifier display mechanism is operable in response to the activation of the gaming machine for displaying a modifier graphic representation selected from a modifier set of graphic representations including a number of modifying elements and a non-modifying element. A winning result for the activation of the gaming machine includes a value defined by a selected base numerical value selected as the base graphic representation for the activation of the gaming machine as modified by a selected modification defined by the modifier graphic representation selected for the activation of the gaming machine.

### CROSS-REFERENCE TO RELATED APPLICATION

Applicant claims the benefit, under 35 U.S.C. § 119(e), of U.S. Provisional Patent Application No. 63/543,103 filed Oct. 8, 2023, and entitled “Gaming Machine Player Interfaces and Interface Methods.” The entire content of this provisional application is incorporated herein by this reference.

### TECHNICAL FIELD OF THE INVENTION

The invention relates to gaming machine player interfaces and interface methods used to display information to a player.

### BACKGROUND OF THE INVENTION

Traditional gaming machines include both mechanical reel and video reel-type gaming machines, video poker gaming machines, and numerous other types of gaming machines that are available for play at casinos or other gaming establishments. Such gaming machines operate to ultimately display a game result for a given activation, and this game result may or may not be associated with a prize to be awarded to the player for the given activation. Various types of game operation and various types of interesting graphics and graphic effects, together with sound effects, have been developed in an effort to provide more entertainment value for players and thereby help maintain the players' interest.

Traditional reel-type gaming machines, both those having mechanical reels and those that display representations of reels on video displays, show a result for an activation of the gaming machine by spinning the reels and then bringing the reels to a stop to show a matrix of game symbols. Certain symbol combinations that may be shown in the matrix may be defined as winning combinations via a suitable paytable and correlate to a prize to be awarded to the player for the given activation of the gaming machine. Thus the presence of any of these predefined symbol combinations in the matrix after a spin of the reels indicates to the player any prize they have won for the given activation of the gaming machine. Beyond the basic spin of the reels to show a result, various anticipation reel spin effects may be performed, various reel respins may be conducted, and other types of bonus games added to the base game to present results to the player in an entertaining fashion.

Both reel-type gaming machines having mechanical reels and those displaying video representations of reels may show game results in terms of numerical values. For example, U.S. Pat. No. 10,950,083, assigned to Everi Games Inc., discloses reel-type gaming systems in which multiple mechanical or video reels are arranged in a traditional fashion along a common horizontal rotational axis. The game symbols appearing on the reels include various numerical values and symbols representing a blank. Once the reels are spun and then stopped for a given play of the game, the result for the play of the game is represented by a concatenation of the numerical symbols aligned along a payline defined through the reel symbols. One benefit of the reel-type gaming system disclosed in U.S. Pat. No. 10,950,083 is that the players do no need to refer to a traditional paytable that correlates the occurrence of reel symbols to various prizes. Rather, the result for the play in the game is readily apparent from the numerical symbols aligned along the payline defined through the reels.

### SUMMARY OF THE INVENTION

It is an object of the invention to provide gaming machine player interfaces and player interface methods that present gaming results in a readily understandable and entertaining fashion. Another object of the invention is to provide gaming machines including such a player interface. The invention also encompasses program products for controlling a gaming machine player interface.

A gaming machine player interface according to a first aspect of the present invention includes a base display mechanism and a first modifier display mechanism. Both of these display mechanisms may be operable in response to an activation of the gaming machine, which may be a player input in the form of pressing a play button or activating some other player control of the gaming machine with which the player interface is associated. The base display mechanism is operable in response to an activation input for displaying a base graphic representation. This base graphic representation is selected from a base set of graphic representations including a number of base numerical values and a graphic representation of a base zero value. The first modifier display mechanism is operable in response to the activation of the gaming machine for displaying a first modifier graphic representation. This first modifier graphic representation is selected from a modifier set of graphic representations including a number of modifying elements and a non-modifying element. A winning result for the activation of the gaming machine includes a value defined by a selected base numerical value selected as the base graphic representation for the activation of the gaming machine as modified by a selected modification defined by the first modifier graphic representation selected for the activation of the gaming machine. For example, the selected base numerical value may be the value “25” and the modification defined by the selected first modifier graphic representation may be the multiplier “10,” in which case the value of the winning result comprises 250 (25 multiplied by 10). A non-winning result for the activation of the gaming machine is represented by the graphic representation of the base zero value displayed by the base display mechanism for that activation of the gaming machine.

As will be apparent from the descriptions of representative embodiments below, the term “mechanism” when referring to a base display mechanism and a modifier display mechanism is used in this disclosure and the accompanying claims to mean a physical structure adapted for displaying a graphic representation selected from a set of such representations. Thus, for example, a base or modifier display mechanism may include a mechanical reel such as a mechanical reel of a slot machine. A video display or a portion of a video display is another example of a base or modifier display mechanism. A mechanical spinnable wheel or other rotating or oscillating structure or a video device displaying a video representation of a spinnable wheel or other rotating or oscillating structure may also be employed as a base or modifier display mechanism in accordance with this disclosure and the accompanying claims.

A second aspect of the invention encompasses gaming machines that include a player interface in accordance with the first aspect of the invention.

A third aspect of the present invention encompasses methods that include displaying a base graphic representation and a first modifier graphic representation as described above in connection with player interfaces in accordance with the present invention.

Because a gaming machine in accordance with the second aspect of the invention may be implemented by a data processing system executing program code, another aspect of the invention encompasses program products comprising one or more non-transitory computer readable data storage devices storing program code. Program code according to this fourth aspect of the invention includes base display mechanism program code and first modifier display mechanism program code. The base display mechanism program code is executable by a data processing system to cause a base display mechanism as described above to display a base graphic representation in response to an activation of the gaming machine. The first modifier display mechanism program code is executable by the data processing system to cause a first modifier display mechanism as described above to display a first modifier graphic representation in response to the activation of the gaming machine. Winning and non-winning results are represented as described above in connection with the first aspect of the invention.

These and other aspects, advantages, and features of the invention will be apparent from the following description of representative embodiments, considered along with the accompanying drawings.

### BRIEF DESCRIPTION OF THE DRAWINGS

FIG. 1 is an isometric view of a gaming machine in accordance with an embodiment of the present invention.

FIG. 2 is a block diagram showing the various components that may be included in the gaming machine shown in FIG. 1.

FIG. 3 is a block diagram of a gaming system including gaming machines such as that shown in FIG. 1.

FIG. 4 is a flow chart of a process in accordance with an embodiment of the present invention.

FIG. 5 is a representation of a gaming machine user interface in accordance with a first embodiment of the invention.

FIG. 6 is a representation of a gaming machine user interface in accordance with a second embodiment of the invention.

FIG. 7 is a more schematic representation of a base portion of the gaming machine user interface shown in FIG. 5.

FIG. 8 is a representation similar to FIG. 7 but with the user interface in a second state.

FIG. 9 is a representation similar to FIG. 7 but with the user interface in a third state showing a non-winning result.

FIG. 10 is a more schematic representation of a base portion of the gaming machine user interface shown in FIG. 6.

FIG. 11 is a representation similar to FIG. 10 but with the user interface in a second state.

FIG. 12 is a representation similar to FIG. 10 but with the user interface in a third state.

FIG. 13 is a representation similar to FIG. 10 but with the user interface in a fourth state.

FIGS. 14-17 are a sequence of representations of a user interface in accordance with an embodiment of the invention including a base replacement mechanism illustrated as a wheel with a number of wheel segments each showing a respective base replacement numerical value.

FIG. 18 is a block diagram showing software data structures and devices that may be employed in an implementation of a result generating processing system within the scope of the present invention.

### DESCRIPTION OF REPRESENTATIVE EMBODIMENTS

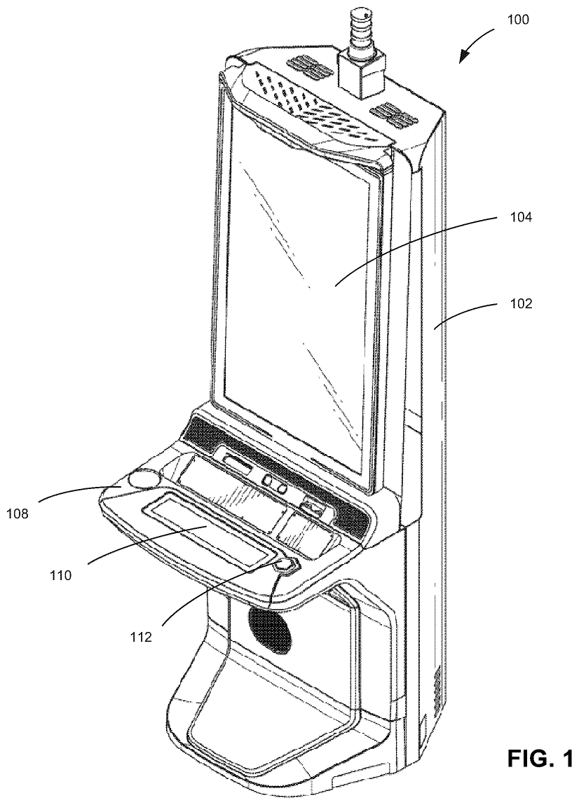

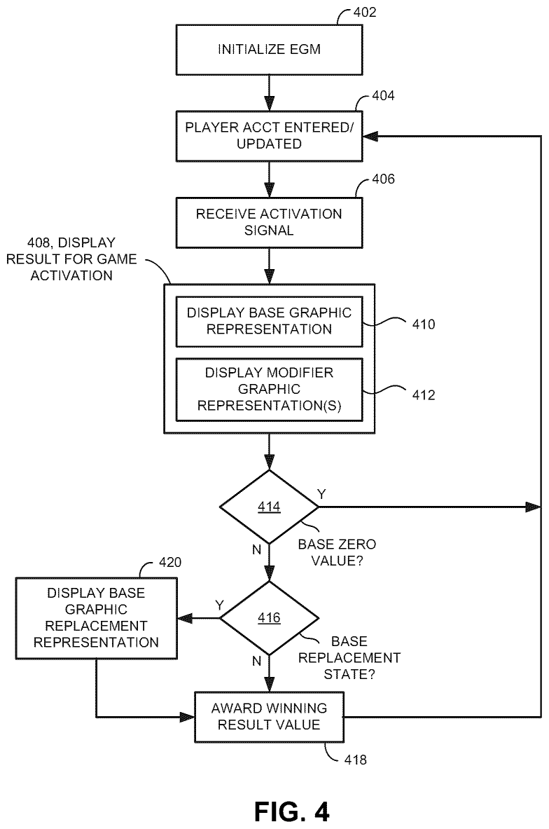

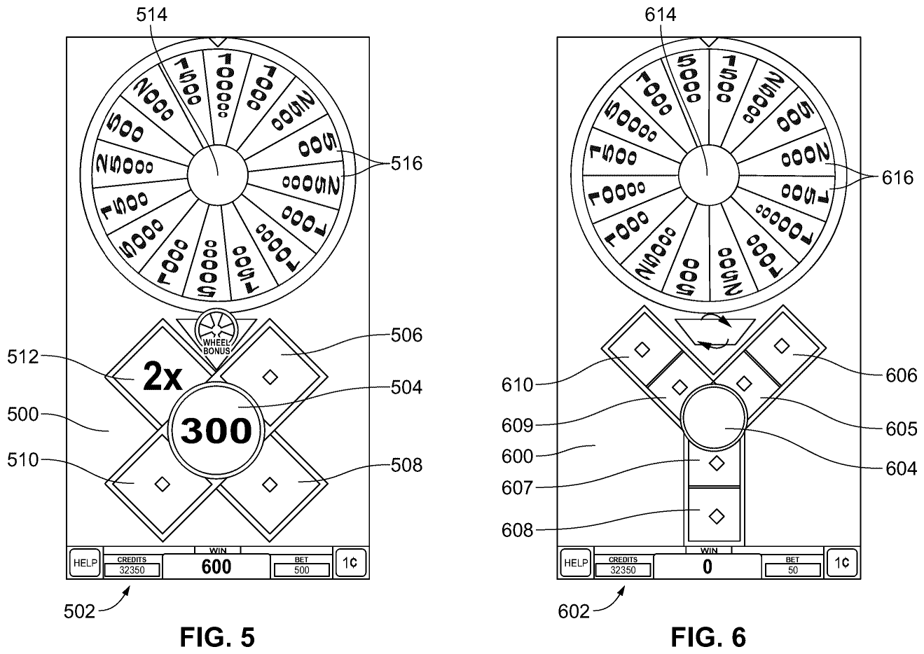

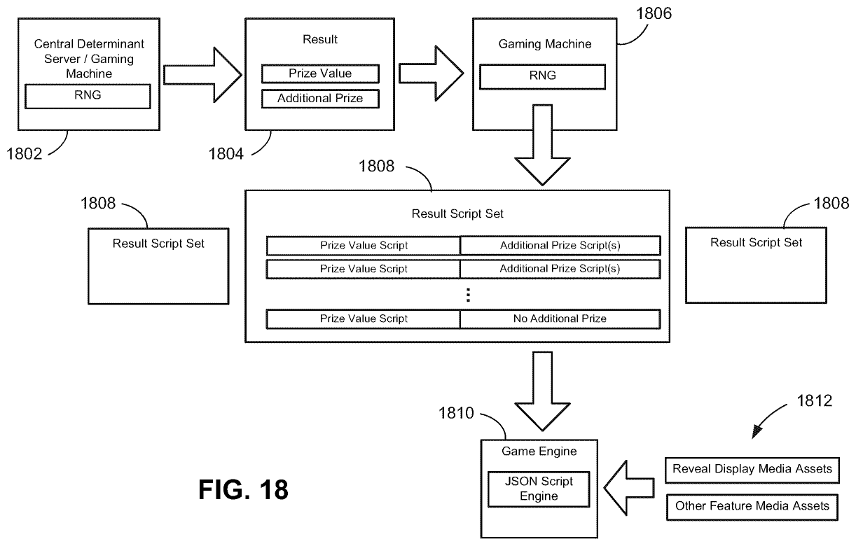

FIGS. 1-3 will be used to describe example gaming machines and gaming networks in which aspects of the present invention may be implemented. FIG. 4 will be used to describe example methods of controlling a gaming machine according to various implementations of the present invention. FIGS. 5-17 will be referenced below to describe player interfaces in accordance with example implementations the present invention. FIG. 18 will be referenced below to describe certain software and data structures that may be employed in implementations of the invention.

Referring to FIG. 1, an example gaming machine 100 includes a cabinet 102 on which is mounted a main display device 104. Example gaming machine 100 also includes a player control deck 108 extending forwardly below main display device 104. This example player control deck 108, which may also be referred to as a “button deck,” includes a player control touchscreen video display device 110 together with a mechanical “play” button 112.

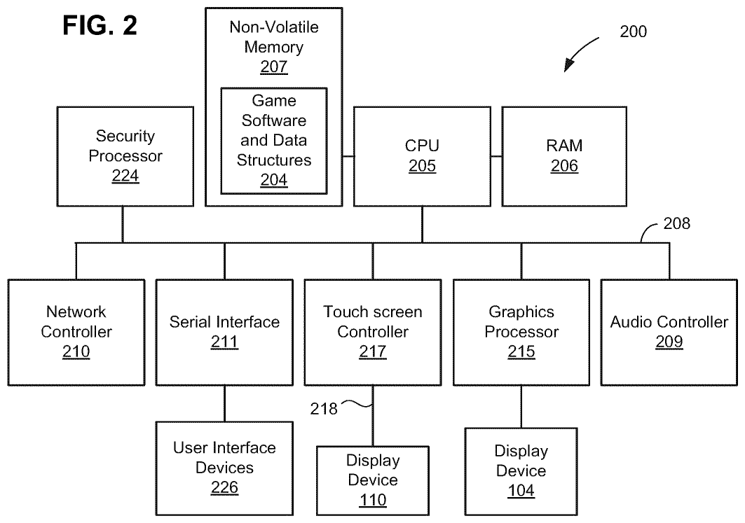

FIG. 2 shows a logical and hardware block diagram 200 of gaming machine 100 that includes a processor (CPU) 205 along with a suitable connection to random access memory (RAM) 206 and a suitable connection to non-volatile memory 207. CPU 205 is connected on a system bus 208 with an audio controller device 209, a network controller 210, a serial interface 211, a graphics processor 215, and a touchscreen controller 217. Graphics processor 215 may provide a suitable video output to main video display device 104. Video display device 104 in this example may comprise an LCD or OLED display monitor, for example, having a forward facing display area. Although not indicated as such in FIG. 2, main display device 104 may comprise a touchscreen display device having a touchscreen element connected via signal path to a suitable touchscreen controller. The illustrated touchscreen controller 217 is shown connected via a signal path 218 to receive signals from a touchscreen element associated with video display device 110 mounted on the player control deck 108 in this example. It will be appreciated that the touchscreen element itself may comprise a thin film element on or associated with the upwardly facing display area of display device 110 and is not shown separately in these views. Also, display device 110 will also be connected to an element of the system, such as graphics processor 215 for example, to receive either a display device driving signal (video signal) or data from which such a signal may be generated.

Those familiar with data processing devices and systems will appreciate that other basic electronic components will be included in gaming machine 100 such as a power supply, cooling systems for the various system components, audio speakers, and other devices that are common in gaming machines. These additional devices are omitted from the drawings so as not to obscure the present invention in unnecessary detail.

All of the elements 205, 206, 207, 208, 209, 210, and 211 shown in FIG. 2 are elements commonly associated with a personal computer, although they may be specially designed and configured so that gaming machine 100 has a hardware configuration approved by one or more regulatory authorities such as the Navada Gaming Commission for use in casino gaming (that is, for use in a wagering game environment). These elements may be mounted on one or more circuit boards housed within cabinet 102 with or without a separate enclosure. Those familiar with data processing systems and the various data processing elements shown in FIG. 2 will appreciate that many variations on this illustrated structure may be used within the scope of the present invention. For example, since serial communications are commonly employed to communicate with a touchscreen controller such as touchscreen controller 217, the touchscreen controller may not be connected on system bus 208, but instead include a serial communications line to serial interface 211 (a USB controller for example). Also, each touchscreen may include a dedicated touchscreen controller. It will also be appreciated that some of the devices shown in FIG. 2 as being connected directly on system bus 208 may in fact communicate with the other system components through a suitable expansion bus. Where such a controller is included in a gaming machine in accordance with the present invention, audio controller 209, for example, may be connected to the system via a PCI or PCIe bus or bus configured according to some other expansion bus standard. System bus 208 is shown in FIG. 2 merely to indicate that the various components are connected in some fashion for communication with CPU 205 and is not intended to limit the invention to any particular bus architecture.

Numerous other variations in the gaming machine internal structure and system may be used without departing from the principles of the present invention. For example, a gaming machine in some embodiments of the present invention may rely on one or more data processors located remotely from the gaming machine itself. Embodiments of the present invention may include no processor such as CPU 205 or graphics processor such as 215 at the gaming machine and may instead rely on one or more remote processors. Thus unless specifically stated otherwise, the designation “gaming machine” is used in this disclosure and the accompanying claims to designate a system of devices that operate together to provide the indicated functions. A “gaming machine” may include a gaming machine such as gaming machine 100 shown in FIGS. 1 and 2, that is itself a system of various components, and may also include one or more components remote from a gaming machine cabinet (that is, remote from the cabinet 102 of gaming machine 100 in FIG. 1). As used herein, the designation “gaming machine” encompasses both a stand-alone gaming machine and a gaming machine along with one or more remote components for providing various functions (such as identifying prizes for a given play and controlling result display graphics and performing other operations).

Although separate graphics processor 215 is shown for controlling display device 104 (and perhaps 110 as well), CPU 205 or a graphics processor packaged with or included with CPU 205 may control all of the display devices directly without any separately packaged graphics processor. The invention is not limited to any particular arrangement of processing devices for controlling the display devices included with gaming machine 100. Also, a gaming machine implementing the present invention is not limited to any particular number of video display devices or any particular types of display devices.

In the illustrated gaming machine 100, CPU 205 executes software, that is, program code represented at 204 in the figure, that ultimately controls the entire gaming machine including the receipt of player inputs and the presentation of the graphics or information displayed through the display devices 104 and 110 and any other display devices associated with the gaming machine. This program code may include various data structures defining various assets (such as graphics assets for example) employed in the course of presenting the given game at gaming machine 100 and performing the process described below in connection with FIG. 4. CPU 205 also executes software related to communications handled through network controller 210, and software related to various peripheral devices such as those connected to the system through audio controller 209, serial interface 211, and touchscreen controller 217. CPU 205 may also execute software to perform accounting functions associated with game play. Random access memory 206 provides memory for use by CPU 205 in executing its various software programs while the nonvolatile memory or storage device 207 may comprise mass storage device providing storage for game software (program code) prior to loading into random access memory 206 for execution, or for programs and program assets not in use or for other data generated or used in the course of gaming machine operation. Network controller 210 provides an interface to other components of a gaming system in which gaming machine 100 may be included.

It should be noted that the invention is not limited to gaming machines employing the specially configured general purpose processing devices and personal computer-type arrangement of processing devices and interfaces shown in example gaming machine 100. Other gaming machines through which the invention may be implemented may include one or more special purpose processing devices to perform the various processing steps for implementing the invention.

FIG. 2 shows the gaming machine including user interface devices 226 (part of a player input system) connected to serial interface 211. These user interface devices may include various player input devices such as “play” button 112 in FIG. 1 and other mechanical buttons, virtual buttons shown on touchscreen video display device 110 in FIG. 1, and/or levers, and other devices. It will be appreciated that the interface between CPU 205 and other player input devices such as player card readers, voucher readers or printers, and other devices may be in the form of serial communications. Thus serial interface 211 may be used for those additional devices as well, or the gaming machine may include one or more additional serial interface controllers. However, the interface between peripheral devices in the gaming machine, such as player input devices, is not limited to any particular type or standard for purposes of the present invention.

FIG. 2 also shows that gaming machine 100 shown in FIG. 1 includes a security processor 224 which may include verified regulated read only memory or flash memory. Security processor 224 in this example comprises a special purpose microprocessor or processor core that functions to control the boot process of gaming machine 100 (FIG. 1) and verify that various firmware and software modules thereon match those approved by the appropriate regulators for modules requiring regulatory verification. This verification may be performed before the modules are loaded into RAM 206 in the example of FIG. 2. Security processor 224 may perform various cryptographic verification procedures to verify such firmware and software modules, including maintaining keys, accessing a key verification authority, and maintaining and checking digital signatures. Security processor 224 may be a separate processor connected on system bus 208 as depicted in FIG. 2 or may be embodied as a processing core within CPU 205 or a processor packaged with CPU 205.

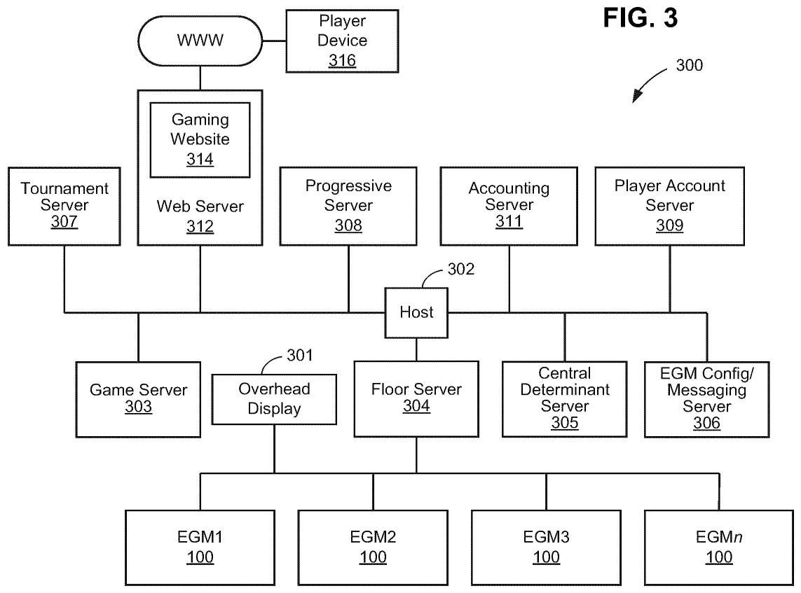

Referring now to FIG. 3, a networked gaming system 300 associated with one or more gaming facilities may include one or more networked gaming machines 100 (shown in FIG. 3 as EGM1-EGMn) connected in the network by suitable network cable or wirelessly. Networked gaming machines 100 and one or more overhead display devices 301 may be operatively connected so that the overhead display device or display devices may mirror or replay the content of one or more displays of gaming machines 100. For example, the display content for a given gaming machine 100 (including a base game portion and/or bonus features) may be transmitted through network controller 210 (in FIG. 2) to a controller associated with the overhead display device 301. In the event gaming machines 100 have cameras installed, the respective player's video images may be displayed on overhead display device 301 along with the content of the player's gaming machine display.

The example gaming network 300 shown in FIG. 3 includes a host server 302 and floor server 304, that together may function as an intermediary between floor devices such as gaming machines 100 and back-office devices such as the various servers described below. Game server 303 may provide server-based games and/or game services to network connected gaming devices such as gaming machines 100. Central determinant server 305 may be included in the network to identify or select lottery, bingo, or other centrally determined game results and provide the result information to networked gaming machines 100 that present the games or game results to players.

EGM configuration and messaging server 306 may provide game and non-game content and operational software for use by the gaming machines 100 in the course of providing games and while the gaming machines are unused and in an idle state. For example, server 306 may control the distribution of game software and graphic control assets to the gaming machines as well as advertising messages and other messages that may be presented using a display device of a gaming machine 100.

Tournament server 307 may be included in the system for controlling or coordinating tournament functions. These functions may include maintaining tournament player scores and ranking during the course of tournament play and communicating this information to the various gaming machines 100 participating in the tournament. Tournament server 307 may also function to enroll players in tournaments, schedule tournaments, and maintain the time remaining in the various tournaments.

Progressive server 308 may maintain progressive pools for progressive games that may be available through the various gaming machines 100. In some implementations, progressive server 308 may simply receive communications indicating contribution amounts that have been determined by processes executing at the various gaming machines 100 or elsewhere in the gaming network. Alternatively, progressive server 308 may perform processes to determine the contribution amounts for incrementing the various progressive pools that may be maintained. Progressive server 308 may also periodically communicate current pool values back to the various gaming machines 100 and may participate in communicating awarded progressive prize amounts to the gaming machines and in adjusting the progressive prize pools accordingly. In some implementations, progressive server 308 may also determine or participate in determining when a progressive prize triggering event occurs.

Accounting server 311 may receive gaming data from each of the networked gaming devices, perform audit functions, and provide data for analytical programs. Player account server 309 may maintain player account records, and store persistent player data such as accumulated player points and/or player preferences (for example, game personalizing selections or options).

Example gaming network 300 also includes a gaming website 314 that may be hosted through web server 312 and may be accessible by players via the Internet. One or more games may be displayed and played by a player through a player device 316 such as a wired or wireless personal computer or handheld wireless device (for example, an Android® operating system smart phone, Apple® iPhone® smart phone, personal digital assistant (PDA), iPad® or other tablet computer, etc.). To enter website 314, a player may log in with a user name that may, for example, be associated with the player's account information stored on player account server 309. Once logged in to website 314 the player may play various games on the website. Also, website 314 may allow the player to make various personalizing selections and save the information so it is available for use during the player's next gaming session at a casino establishment having the gaming machines 100.

Gaming network 300 illustrated in FIG. 3 is provided merely as an example of a gaming network that may include gaming machines with display assemblies according to aspects of the present invention and is not intended to be limiting in any way. Gaming machines having one or more display assemblies with integrated audio speakers according to aspects of the present invention are not limited to use with gaming networks such as network 300.

The flowchart of FIG. 4 shows an example process in accordance with an implementation of the present invention which may be performed through a gaming machine such as the example gaming machine 100 shown in FIG. 1. The illustrated process begins with a list initializing the gaming machine (EGM) shown at process block 402. This initialization comprises the boot up process for placing the gaming machine in condition to operate in accordance with the applicable regulatory environment. The initialization process may include security processing conducted by a security processor such as processor 224 in FIG. 2 to ensure the gaming machine is specially configured for a gaming environment.

Once the gaming machine is initialized and the game software is executing on the gaming machine, the process includes placing the gaming machine in condition for accepting a player activation. This process may include accessing a player account at the gaming machine or otherwise placing funds on the gaming machine as indicated at process block 404.

With the gaming machine enabled for receiving an activation for a play of the game, the process includes receiving an activation signal as indicated at process block 406. This activation signal may be generated in response to an input by the player through a suitable player input device such as a play button or handle associated with the gaming machine, for example a press of mechanical button 112 shown in FIG. 1 or some other player input device. The player may first be required to set a wager level for the activation of the gaming machine. This may be part of the input to produce an activation of the gaming machine for a play or may be part of the process shown at process block 404.

In response to the activation of the gaming machine, the process shown in FIG. 4 includes displaying a result graphic as shown at process block 408. The process includes displaying a base graphic representation as indicated at process block 410. This base graphic representation is selected from a base set of graphic representations including a number of base numerical values and a graphic representation of a base zero value. For example, the base set of graphic representations may include the base numerical values “1,” “5,” “25,” “50,” “100,” and “300.” The graphic representation of a base zero value may comprise the numeral “0” or simply a blank or some other symbol defined as representing the value “0.” Of course all of the graphic representations representing base numerical values may be presented as a non-numerical value that is defined as representing a numerical value. For example, the numerical value “100” in the base numerical values may be represented as a graphic representation of a star or some other object. The process shown at process block 408 also includes displaying one or more modifier graphic representations as indicated at process block 412. These modifier graphic representations will include at least a first modifier graphic representation selected from a modifier set of graphic representations including a number of modifying elements and a non-modifying element. The modifying elements may for example comprise numerical multiplier values such as 2×, 5×, 10×, and 20×. The non-modifying element may comprise a blank for example or some graphic representation indicating that the displayed value does not modify the value associated with the base graphic representation.

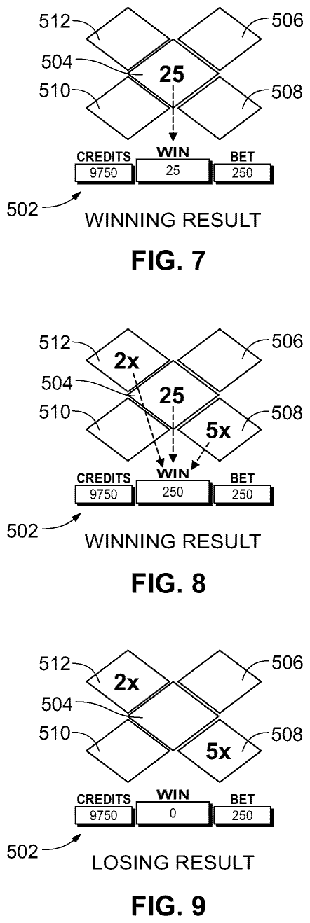

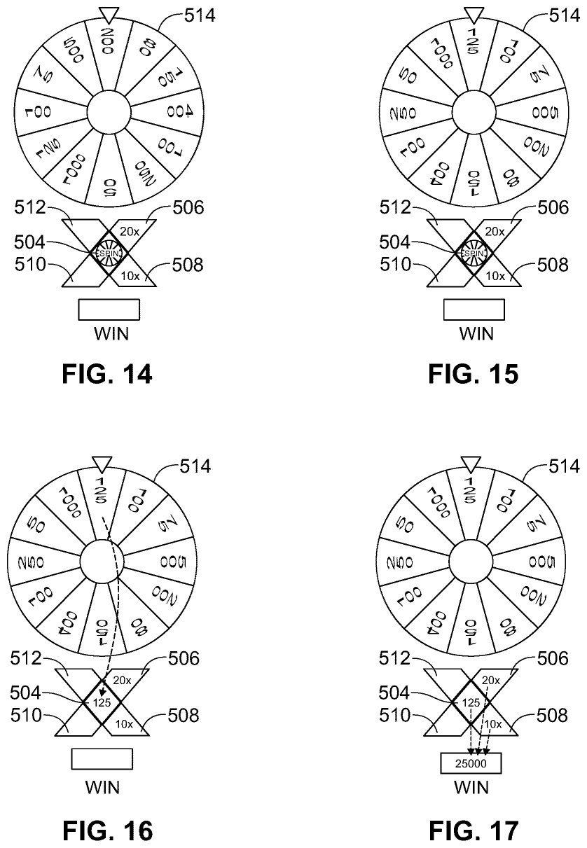

In the event the base graphic representation comprises the graphic representation of a base zero value for this activation of the gaming machine (the activation at 406) the result for the activation of the gaming machine is a non-winning result and the process loops from decision box 414 back to process block 404 where the player may place more funds on the gaming machine or simply proceed to make another activation input at process block 406. However, if the displayed base graphic representation does not comprise a base zero value as indicated by a negative outcome at decision box 414, the example process shown in FIG. 4 proceeds to decision box 416. If the base graphic representation displayed as indicated at process block 410 is in a base replacement state, the process proceeds to process block 420 to display a base graphic replacement representation. An example of this base graphic replacement representation and base replacement state will be described below in connection with FIGS. 14-17. After the display of the base graphic replacement representation as indicated at process block 420 or in the event that the base graphic representation is not in a base replacement state, the process shown FIG. 4 includes awarding the winning result value at process block 418 before looping back to receive more player account activity at process block 404 or receive another activation signal at process block 406. Examples of winning result values where there is no base replacement state at decision box 416 will be described below in connection with FIGS. 7-13.

FIGS. 5 and 6 show two different examples of an overall graphic display showing a user interface in accordance with aspects of the invention which may be shown for example on display device 104 shown in FIG. 1. Referring to FIG. 5, the display 500 includes a series of display boxes 502 at the bottom of the display area. These display boxes may for example include a display box showing the current denomination for an activation of the gaming machine, a total number of credits available for activations, a current or most recent win value, and a current wager/activation value. Above the set of boxes 502, display 500 shows a base display mechanism 504 for displaying a base graphic representation for a given activation of the gaming machine. This example implementation also includes four separate modifier display mechanisms 506, 508, 510, and 512, each operable for displaying a respective modifier graphic representation. The display mechanisms 504, 506, 508, 510, and 512 in this example comprise video representations of spinnable reels. Each reel has on its periphery the respective set of graphical representations from which a selection is made for an activation of the gaming machine. The example of FIG. 5 shows the numerical value “300” as the base graphic representation on base display device 504 which indicates that the base set of graphic representations for the example of FIG. 5 includes “300” as one of the number of base numerical values. The example of FIG. 5 also shows the modifier graphic representation “2×” shown on modifier display mechanism 512 as a modifying element, while modifier display mechanisms 506, 508, and 510 show blank symbols representing no numerical value, that is, a non-modifying element. The state of display 500 in FIG. 5 produced in response to a given activation of the gaming machine shows a result value of 600 comprising the numeric value of the base graphic representation at mechanism 504 multiplied by the multiplier “2×” shown at modifier display mechanism 512.

The example display of FIG. 5 also shows a base replacement display mechanism 514 comprising a wheel divided into a number of wheel segments 516. Each wheel segment 516 is associated with a numerical value. This replacement display mechanism 514 for display 500 may be used to display a base graphic replacement representation as indicated by process block 420 in FIG. 4. An example application of this display arrangement to affect the result for an activation of the gaming machine will be described below in connection with FIGS. 14-17.

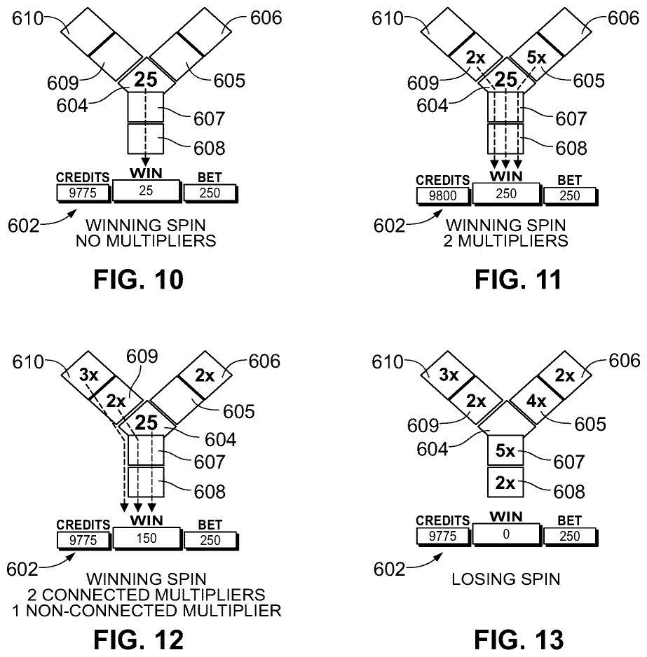

The example display 600 shown in FIG. 6 includes a set of display boxes 602 similar to the set of display boxes 502 shown in FIG. 5. Display 600 also includes a base replacement display mechanism comprising a wheel 614 with wheel segments 616 similar to the segmented wheel 514 shown in FIG. 5. Display 600 differs from display 500 in the arrangement of the base display mechanism and modifier display mechanisms. In particular, display 600 in FIG. 6 shows a base display mechanism 604 with a total of six different modifier display mechanisms 605, 606, 607, 608, 609, and 610. In this example implementation each of these display mechanisms comprises a video representation of a spinnable reel. The spinnable reel comprising base display mechanism 604 includes on its periphery the base set of graphic representations from which a selection is made to display a base graphic representation (the process shown at process block 410 in FIG. 4). Each of the reels representing a respective modifier display mechanism includes along its periphery graphic representations from which a respective modifier graphic representation is selected for an activation of the gaming machine (the process shown at process block 412 in FIG. 4). A specific example of the operation of the arrangement shown at display 600 for displaying a result with only the base display mechanism 604 and the modifier display mechanisms 605 through 610 will be described below in connection with FIGS. 10-13.

Each of FIGS. 7-9 show an example of the base display mechanism 504 and modifier display mechanisms 506, 508, 510, and 512 for displaying a result value in accordance with the present invention. FIG. 7 shows base display mechanism 504 displaying the numerical value “25” in response to an activation of the gaming machine while each of the modifier display mechanisms 506, 508, 510, and 512 show a blank symbol representing a non-modifying element in this implementation. Thus the result shown by the state of the display mechanisms in FIG. 7 is a win of 25.

FIG. 8 shows base display mechanism 504 displaying the numerical value “25” in response to an activation of the gaming machine while modifier display mechanism 508 shows the symbol “5×” representing a multiplier value of five and modifier display mechanism 512 shows a symbol “2×” representing a multiplier value of two. Thus the results shown by the state of the display mechanisms in FIG. 8 is a win of 250, the base numerical value for the base graphic representation shown in this example state multiplied by the multiplier value five shown at modifier display mechanism 508 and multiplied by the multiplier value two shown at modifier display mechanism 512 (25×5×2=250).

FIG. 9 shows a state of the base display mechanism 504 and modifier display mechanisms 506, 508, 510, and 512 for a non-winning result. In particular FIG. 9 shows that base display mechanism 504 displays a graphic representation of a base zero value represented in this case by a blank on the simulated reel. Thus although modifier display mechanism 508 shows a multiplier value as does modifier display mechanism 512, the non-winning result of zero is obtained because those multiplier values are applied to the base zero value shown at base display mechanism 504 (that is, 2×5×0=0).

Each of FIGS. 10-13 show an example of the base display mechanism and modifier display mechanism arrangement shown in FIG. 6 to display a particular result for an activation of the gaming machine. The example of FIG. 10 shows a state produced in response to an activation of the gaming machine in which the base display mechanism 604 shows the numerical value “25” while each of the modifier display mechanisms 605-610 shows a blank symbol, that is, a non-modifying element. Thus the result shown in the state of FIG. 10 comprises the value “25.”

In the state shown in FIG. 11, base display mechanism 604 shows a value “25” in response to a game activation while modifier display mechanism 609 shows a “2×” multiplier and modifier display mechanism 605 shows a “5×” multiplier. The rest of the modifier display mechanisms show a blank representing a non-modifying element in our example. Thus the state of the display shown in FIG. 11 comprises a result value of “250,” produced by multiplying the numerical value of the base graphic representation “25” by the “2×” multiplier and “5×” multiplier.

The example shown in FIG. 12 shows base display mechanism 604 displaying the numerical value “25” in response to an activation of the gaming machine. Modifier display mechanism 610 shows a “3×” multiplier value, modifier display mechanism 609 shows a “2×” multiplier value and modifier display mechanism 606 shows a “2×” multiplier value with the remaining modifier display mechanisms showing a blank symbol representing a non-modifying element. In this example the two connected multiplier values 2× and 3× extending from base display mechanism 604 apply to the value “25” to produce a winning result of 150 (that is 25×2×3=150). The modifying element “2×” shown at modifier display mechanism 605 does not affect the result in this example because it is not adjacent to display mechanism 604 or two another modifier value shown on an adjacent modifier display mechanism. Alternate implementations may apply all modifier values regardless of whether they are connected to base display mechanism 604 or otherwise.

The example shown in FIG. 13 shows a non-winning result produced by a base graphic representation comprising a base zero value shown on base display mechanism 604 for the activation of the gaming machine. Although each of the modifier display mechanisms 605 through 610 show a modifier graphic representation comprising a modifying element, the result of multiplying all these multiplier elements to the zero value represented at base display mechanism 604 still produces a result of zero.

FIGS. 14-17 may be used to describe the operation of the replacement display mechanism represented by wheel 514 also shown in the display of FIG. 5. It will be noted that the wheel 514 shown in each of FIGS. 14-17 is shown in a somewhat simplified form as compared to FIG. 5. FIG. 14 shows the state of the base display mechanism 504 and modifier display mechanisms 506, 508, 510, and 512 that will result in the activation of the replacement display mechanism 514. In particular, base display mechanism 504 is shown as landing on a “spin” symbol (a non-numerical symbol representing a base graphic replacement representation) in response to an activation of the gaming machine while modifier display mechanism 506 shows a 20× multiplier value and modifier display mechanism 508 shows a 10× multiplier value for this activation of the gaming machine. This “spin” result landing at base display mechanism 504 causes the wheel 514 to spin and, as shown in FIG. 15, ultimately land on the wheel segment showing the value “125,” that is, a value of 125. FIG. 16 shows this “125” value replacing the “spin” symbol in the base display mechanism 504 thus applying this “125” value to the multipliers “10×” and “20×” shown in response to the activation of the gaming machine resulting in a result value of 25,000 credits (125×10×20) for the activation of the gaming machine. Although FIGS. 14 to 17 indicate the use of the replacement display mechanism comprising a wheel 514 associated with display 500, the replacement display mechanism indicated by wheel 614 in FIG. 6 may operate similarly in accordance with the present invention.

The scope of the present invention encompasses numerous variations on the example user interfaces shown in FIGS. 5-17. For example, although the example modifier values all operate as multipliers, the modification to the base graphic representation may be any other type of modification. Also, although the example displays 500 and 600 show the based display mechanism arranged in an “X” and “Y” shape, respectively, with the modifier display mechanisms, the various display mechanisms may be arranged in any identifiable or unidentifiable shape. Furthermore, although the invention is well suited for employing video simulated or mechanical reels as the base and modifier display mechanisms, any suitable display mechanism may be employed including wheels having segments populated with the desired set of graphic elements and combinations of reels and wheels. Additionally, the base set of graphic representations and any of the modifier sets of graphic representations may include respin symbols which result in one or more respins of the display mechanisms to cumulatively display the result for the activation of the gaming machine.

FIG. 18 comprises a block diagram of software and data structures that may be employed in embodiments of the present invention to generate the results displayed by the various display mechanisms in implementations of the present invention. The block diagram of FIG. 18 shows an arrangement 1802 for generating a first random number, an arrangement 1804 for obtaining a result based on that first random number, and an arrangement 1806 for generating a second random number. The result from 1804 is used to select a result script set 1808 corresponding to that result and the second random number from 1806 is used to select a result script from the selected script set. Game engine 1810 is operable to execute the selected result script to control the gaming machine display system to display the randomly selected result for the given game activation input using media assets 1812 from an arrangement for storing such assets.

For centralized gaming architectures, a device such as a central determinant server (305 in FIG. 3 for example) may comprise the random number generating arrangement 1802. In such a centralized gaming architecture, the gaming machine may request a random number when a result is needed as will be described further below, and the central determinant server may include a random number generator that communicates the first random number to the gaming machine in response to the request. In many Class III type gaming systems, the random number generating arrangement 1802 comprises a random number generator at the gaming machine itself. In either case the random number generator may be a hardware-based random number generator or other random number generator conforming to applicable regulations for both security and randomness.

The arrangement 1804 for selecting a result based on the random number from block 1802 may likewise reside at a centralized device such as a central determinant server in a centralized gaming architecture or at the gaming machine itself. In either case, the arrangement 1804 may select a result by using the first random number from 1802 to select from a pool of available results to produce a desired prize distribution and payout percentage. Thus the application of arrangements 1802 and 1804 represent a result generation or identification process.

The second random number generating arrangement 1806 in FIG. 18 comprises any suitable arrangement for generating a second random number. Where the gaming machine includes the arrangement 1802 for generating the first random number, the arrangement 1806 may comprise the same random number generator used to generate the first random number. Regardless of which specific element in the system is used to generate the second random number, that second random number is used in this example implementation of FIG. 18 together with the result selected at 1804 to select a specific result script to display the result at the gaming machine. Specifically, the gaming machine uses the result from 1804 to select a result script set 1808 that includes result scripts to show that particular result, that is, the prize associated with that result. The gaming machine also uses the second random number from block 1806 to select a specific one of the result scripts in the selected result script set 1808. For example, if the overall result to be revealed correlates to a result of 1000 credits, the set 1808 containing scripts showing a 1000-credit overall result for the given activation selection input is selected and the second random number is used to select one of these scripts. The given script selected from a set 1808 may show only the result revealed by base display and modifier display mechanisms in accordance with the invention or revealed additionally using a base replacement display mechanism such as the wheel 514 in FIG. 5 for example.

The specific script selected from the set 1808 for the result to be awarded is then loaded to the game engine 1810 and executed to cause the display system to display the desired graphics. The game engine 1810 may, for example, include a JSON script engine. Regardless of the nature of game engine 1810, it may access media assets 1812 stored in the game software and use these media assets to cause the gaming machine display system to display the game result. The media assets 1812 may include data structures for driving the various graphic elements shown in displays according to the present invention.

In other implementations of a prize revealing arrangement according to the present invention, the result script sets may not be stored as indicated at 1808 in FIG. 18 and selected with a second random number by the arrangement shown at 1806. In these implementations, control signals to cause the gaming machine display system to generate the displays for revealing the prize value in accordance with the present invention may be generated in response to the random result selected at the arrangement 1804 in FIG. 18. In particular, the result selected at 1804 may include a prize value to be displayed/revealed in accordance with the present invention and then the display control commands for controlling the display mechanisms to reveal that prize value may be built according to a suitable process.

Regardless of whether control scripts are generated ahead of time and stored as shown in FIG. 18, or whether they are generated “on-the-fly” in response to the result selected at 1804 in FIG. 18, the control for the display devices may be built by the same process.

In implementations of the invention where the result for each player selection is obtained via a lottery ticket or record set, first random number generator 1802 shown in FIG. 18 may be replaced by the lottery record selection system. The result dictated by the lottery record may then be used to select the corresponding result script set 1808 in FIG. 18, and a script may be randomly selected from that script set. A bingo gaming system could also be used in place of the first random number device 1802. Also, in either the lottery type system or bingo system, the result for the player selection may also dictate a specific script without the need for a random number as generated at 1806 in FIG. 18.

It should also be noted that regardless of whether a random number generator is used to select the result to be displayed to the player as indicated in FIG. 18, or whether the result identification process relies on a lottery ticket set or a bingo gaming system, the result identification process may be specific to a wager level for a given activation. That is, each activation level may employ a result identification process to produce a particular volatility and return to player that may be different from those characteristics at another activation level.

The results displayed in a player interface in accordance with the present invention may not be dictated by a scripted process as described in FIG. 18. Random results may alternatively be produced by spinning and randomly stopping reel display mechanisms and wheel display mechanisms as is known in the art.

As used herein, whether in the above description or the following claims, the terms “comprising,” “including,” “carrying,” “having,” “containing,” “involving,” and the like are to be understood to be open-ended, that is, to mean including but not limited to. Also, it should be understood that the terms “about,” “substantially,” and like terms used herein when referring to a dimension or characteristic of a component indicate that the described dimension/characteristic is not a strict boundary or parameter and does not exclude variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

Any use of ordinal terms such as “first,” “second,” “third,” etc., in the following claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

In the above descriptions and the following claims, terms such as “top,” “bottom,” “upper,” “lower,” and the like are used with reference to the orientation of the figures unless specifically stated otherwise.

The term “each” may be used in the following claims for convenience in describing characteristics or features of multiple elements, and any such use of the term “each” is in the inclusive sense unless specifically stated otherwise. For example, if a claim defines two or more elements as “each” having a characteristic or feature, the use of the term “each” is not intended to exclude from the claim scope a situation having a third one of the elements which does not have the defined characteristic or feature.

The above described preferred embodiments are intended to illustrate the principles of the invention, but not to limit the scope of the invention. Various other embodiments and modifications to these preferred embodiments may be made by those skilled in the art without departing from the scope of the present invention. For example, in some instances, one or more features disclosed in connection with one embodiment can be used alone or in combination with one or more features of one or more other embodiments. More generally, the various features described herein may be used in any working combination.

1. A gaming machine user interface including:
(a) a base display mechanism operable for, in response to an activation of a gaming machine, displaying a base graphic representation, the base graphic representation being selected from a base set of graphic representations including a number of base numerical values and a graphic representation of a base zero value;
(b) a first modifier display mechanism operable for, in response to the activation of the gaming machine, displaying a first modifier graphic representation, the first modifier graphic representation being selected from a modifier set of graphic representations including a number of modifying elements and a non-modifying element;
(c) wherein a winning result for the activation of the gaming machine includes a value defined by a selected base numerical value selected as the base graphic representation for the activation of the gaming machine as modified by a selected modification defined by the first modifier graphic representation selected for the activation of the gaming machine; and
(d) wherein the graphic representation of the base zero value displayed by the base display mechanism for the activation of the gaming machine represents a non-winning result for the activation of the gaming machine.

2. The gaming machine user interface of claim 1 wherein the base display mechanism comprises a base display mechanical reel or a base display video reel representation.

3. The gaming machine user interface of claim 2 wherein the first modifier display mechanism comprises a first modifier display mechanical reel or a first modifier video reel representation.

4. The gaming machine user interface of claim 1 wherein the graphical representation of the base zero value comprises a blank symbol.

5. The gaming machine user interface of claim 1 wherein at least one of the number of base numerical values is represented by a non-numerical graphic element.

6. The gaming machine user interface of claim 1 wherein at least one of the number of modifying elements comprises a multiplier value.

7. The gaming machine user interface of claim 1 wherein the non-modifying element comprises a blank symbol.

8. The gaming machine user interface of claim 1 further including a base replacement display mechanism operable for, in response to a replacement state for the base graphic representation, displaying a base graphic replacement representation, the base graphic replacement representation being selected from a set of base replacement graphic representations including a number of base replacement numerical values, and wherein the base set of graphic representations includes a graphic representation corresponding to the replacement state for the base graphic representation.

9. The gaming machine user interface of claim 8 wherein the base replacement display mechanism comprises:
(a) a mechanical wheel with a number of wheel segments each displaying one of the base graphic replacement representations of the set of base replacement graphic representations; or
(b) a video representation of a mechanical wheel with a number of video wheel segments each displaying one of the base graphic replacement representations of the set of base replacement graphic representations.

10. The gaming machine user interface of claim 1 further including:
(a) at least one additional modifier display mechanism, each additional modifier display mechanism being operable for, in response to the activation of the gaming machine, displaying a respective additional modifier graphic representation, the respective additional modifier graphic representation being selected from a respective additional modifier set of graphic representations including a number of additional modifier numerical values and an additional modifier non-numerical value; and
(b) wherein the winning result for the activation of the gaming machine includes the value defined by the selected base numerical value selected as the base graphic representation for the activation of the gaming machine as modified by the selected modification defined by the first modifier graphic representation selected for the activation of the gaming machine further modified by a selected additional modification defined by the respective additional modifier graphic representation selected for the activation of the gaming machine.

11. The gaming machine user interface of claim 10 wherein:
(a) the base display mechanism is arranged along a first axis with respect to the first modifier display mechanism;
(b) the at least one additional modifier display mechanism includes a first additional modifier display mechanism; and
(c) the base display mechanism is arranged along a second axis with respect to the first additional modifier display mechanism, the second axis extending transverse to the first axis in a plane of the gaming machine user interface.

12. The gaming machine user interface of claim 10 wherein:
(a) the base display mechanism is arranged along a first axis with respect to the first modifier display mechanism;
(b) the at least one additional modifier display mechanism includes a first additional modifier display mechanism and a second additional modifier display mechanism; and
(c) the base display mechanism is arranged along a second axis with respect to the first additional modifier display mechanism and second additional modifier display mechanism, the second axis extending transverse to the first axis in a plane of the gaming machine user interface.

13. The gaming machine user interface of claim 10 wherein:
(a) the base display mechanism is arranged along a first axis with respect to the first modifier display mechanism;
(b) the at least one additional modifier display mechanism includes a first additional modifier display mechanism; and
(c) the base display mechanism is arranged along the first axis with respect to the first additional modifier display mechanism.

14. The gaming machine user interface of claim 13 wherein the first modifier display mechanism is interposed along the first axis between the base display mechanism and the first additional modifier display mechanism.

15. A gaming machine including a gaming machine user interface according to claim 1.

16. A method including:
(a) under control of a data processing system associated with a gaming machine and in response to an activation of the gaming machine, displaying a base graphic representation, the base graphic representation being selected from a base set of graphic representations including a number of base numerical values and a graphic representation of a base zero value;
(b) under control of the data processing system associated with the gaming machine and in response to the activation of the gaming machine, displaying a first modifier graphic representation, the first modifier graphic representation being selected from a modifier set of graphic representations including a number of modifying elements and a non-modifying element;
(c) wherein a winning result for the activation of the gaming machine includes a value defined by a selected base numerical value selected as the base graphic representation for the activation of the gaming machine as modified by a selected modification defined by the first modifier graphic representation selected for the activation of the gaming machine; and
(d) wherein the graphic representation of the base zero value displayed for the activation of the gaming machine represents a non-winning result for the activation of the gaming machine.

17. The method of claim 16 further including:
(a) under control of the data processing system associated with the gaming machine and in response to the activation of the gaming machine, displaying a first additional modifier graphic representation, the first additional modifier graphic representation being selected from a first additional modifier set of graphic representations including a number of first additional modifier numerical values and a first additional modifier non-numerical value; and
(b) wherein the winning result for the activation of the gaming machine includes the value defined by the selected base numerical value selected as the base graphic representation for the activation of the gaming machine as modified by the selected modification defined by the first modifier graphic representation selected for the activation of the gaming machine further modified by a selected first additional modification defined by the first additional modifier graphic representation selected for the activation of the gaming machine.

18. The method of claim 17 further including:
(a) under control of the data processing system associated with the gaming machine and in response to the activation of the gaming machine, displaying at least one further modifier graphic representation, the respective further modifier graphic representation being selected from a respective further modifier set of graphic representations including a number of further modifier numerical values and a further modifier non-numerical value; and
(b) wherein the winning result for the activation of the gaming machine includes the value defined by the selected base numerical value selected as the base graphic representation for the activation of the gaming machine as modified by the modification defined by the first modifier graphic representation selected for the activation of the gaming machine and as modified by a respective selected further modification defined by the respective further modifier graphic representation selected for the activation of the gaming machine.

19. A program product comprising one or more non-transitory computer readable data storage devices storing program code, the program code including:
(a) base display mechanism program code executable by a data processing system to cause a base display mechanism to display a base graphic representation in response to an activation of a gaming machine, the base graphic representation being selected from a base set of graphic representations including a number of base numerical values and a graphic representation of a base zero value;
(b) first modifier display mechanism program code executable by the data processing system to cause a first modifier display mechanism to display a first modifier graphic representation in response to the activation of the gaming machine, the first modifier graphic representation being selected from a modifier set of graphic representations including a number of modifying elements and a non-modifying element;
(c) wherein a winning result for the activation of the gaming machine includes a value defined by a selected base numerical value selected as the base graphic representation for the activation of the gaming machine as modified by a selected modification defined by the first modifier graphic representation selected for the activation of the gaming machine; and
(d) wherein the graphic representation of the base zero value displayed by the base display mechanism for the activation of the gaming machine represents a non-winning result for the activation of the gaming machine.

20. The program product of claim 19 further including:
(a) additional modifier display mechanism program code for each of at least one additional modifier display mechanism, each additional modifier display mechanism program code executable by the data processing system to cause a respective additional modifier display mechanism to display a respective additional modifier graphic representation, the respective additional modifier graphic representation being selected from a respective additional modifier set of graphic representations including a number of additional modifier numerical values and an additional modifier non-numerical value; and
(b) wherein the winning result for the activation of the gaming machine includes the value defined by the selected base numerical value selected as the base graphic representation for the activation of the gaming machine as modified by the selected modification defined by the first modifier graphic representation selected for the activation of the gaming machine and further modified by a selected additional modification defined by the respective additional modifier graphic representation selected for the activation of the gaming machine.
